(19) United States
(12) Patent Application Publication
(10) Pub. No.: US 2025/0292571 A1
(43) Pub. Date: Sep. 18, 2025

(54) SYSTEMS AND METHODS FOR RECURRENT GRAPH NEURAL NET-BASED PLAYER ROLE IDENTIFICATION

(71) Applicant: STATS LLC, Chicago, IL (US)

(72) Inventors: Suraj MAURYA, Jaunpur (IN); Pradip GUPTA, Hyderabad (IN); Marek CERNY, Prague (CZ); Sateesh PEDAGADI, London (GB); Carlos Gallardo POLANCO, Cádiz (ES); Sagar HALESH, Channagiri (IN); Patrick Joseph LUCEY, Chicago, IL (US)

(73) Assignee: STATS LLC, Chicago, IL (US)

(21) Appl. No.: 19/077,929

(22) Filed: Mar. 12, 2025

Related U.S. Application Data
(60) Provisional application No. 63/639,850, filed on Apr. 29, 2024.

(30) Foreign Application Priority Data
Mar. 13, 2024 (IN) 202411018318

(51) Int. Cl. G06V 20/40; G06T 7/70; G06V 10/75; G06V 10/82; G06V 40/16

(52) U.S. Cl. CPC G06V 20/42; G06T 7/70; G06V 10/751; G06V 10/82; G06V 40/172; G06T 2207/10016; G06T 2207/30221

(57) ABSTRACT

A method for identifying a player in a sports event, the method including: receiving a video feed of a sporting event; capturing, by a computing system, positional data of a player in one or more video frames of the video feed; receiving, by the computing system, team formation data for at least one team in the sporting event, wherein the team formation data comprises a player role associated with each player; determining, by the computing system, a correspondence between the positional data of a player and the team formation data; and generating, by the computing system, a player identification for the player, wherein the player identification is based on the correspondence between the positional data for the player and a player role from the team formation data.

### CROSS-REFERENCE TO RELATED APPLICATIONS

This application claims the benefit of priority to Indian provisional application 20/241,1018318, filed Mar. 13, 2024, and to U.S. Provisional Patent Application No. 63/639,850, filed Apr. 29, 2024, the entirety of which is incorporated by reference herein.

### TECHNICAL FIELD

Various aspects of the present disclosure relate generally to machine learning for sports applications, in particular various aspects relate to machine learning techniques for identification of player identity and player role/position in a video feed of a sports match.

### INTRODUCTION

The automatic identification of particular players and/or their role/position in a sports match within a video feed and/or broadcast setting is particularly important for data collection, tracking, and other applications during monitoring of a sports game. These tasks are particularly important in machine learning and computer-vision applications where various factors affect the accuracy of identifying a particular player or a particular player's role/position, including poor video encoding or video quality, player occlusion, and similar appearances of players across different teams.

Unless otherwise indicated herein, the techniques and information described in this section are not prior art to the claims in this application and are not admitted to be prior art, or suggestions of the prior art, by inclusion in this section.

### SUMMARY

In some aspects, techniques described herein relate to a method for identifying a player in a sports event, the method including: receiving a video feed of a sporting event; capturing, by a computing system, positional data of a player in one or more video frames of the video feed; receiving, by the computing system, team formation data for at least one team in the sporting event, wherein the team formation data includes a player role associated with each player; determining, by the computing system, a correspondence between the positional data of a player and the team formation data; and generating, by the computing system, a player identification for the player, wherein the player identification is based on the correspondence between the positional data for the player and a player role from the team formation data.

In some aspects, techniques described herein relate to a method, wherein capturing position data of a player in one or more video frames of the video feed includes: assigning an x, y coordinate values to the player relative to a field of the sporting event; and assigning a time stamp to the x, y coordinate values.

In some aspects, techniques described herein relate to a method, wherein generating the player identification for the player further includes: receiving a set of jersey numbers for each player in the sporting event; identifying an associated number with the player from the video feed, the associated number having an assigned confidence value; determining that the associated number matches an assigned jersey number from the set of jersey numbers; and determining that the confidence value is above a threshold value.

In some aspects, techniques described herein relate to a method, wherein generating the player identification for the player further includes: receiving a set of facial construction data for each player in the sporting event; identifying data of a facial reconstruction of the player from the video feed; and determining that the facial reconstruction of the player matches facial construction data received for the player.

In some aspects, techniques described herein relate to a method, wherein the team formation data includes a positional setup of players on a field of the sporting event.

In some aspects, techniques described herein relate to a method, wherein the team formation data is generated, by the computing system, based on exemplary data captured prior to a start of the sports event.

In some aspects, techniques described herein relate to a method, further including: retrieving event data related to the sporting event, and based upon the retrieved event data, updating the team formation data dynamically.

In some aspects, techniques described herein relate to a method, wherein updating the team formation data includes: updating a formation for the at least one team or a listing of players in the sporting event.

In some aspects, techniques described herein relate to a method, wherein correspondence between the positional data of the player and the team formation data is determined by a graph recurrent neural network.

In some aspects, techniques described herein relate to a system for identifying a player in a sports event, the system including: a memory configured to store processor-readable instructions; and a processor operatively connected to the memory, and configured to execute the instructions to perform operations including: receiving a video feed of a sporting event; capturing, by a computing system, positional data of a player in one or more video frames of the video feed; receiving, by the computing system, team formation data for at least one team in the sporting event, wherein the team formation data including a player role associated with each player; determining, by the computing system, a correspondence between the positional data of a player and the team formation data; and generating, by the computing system, a player identification for the player, wherein the player identification is based on the correspondence between the positional data for the player and a player role from the team formation data.

In some aspects, techniques described herein relate to a system, wherein capturing position data of a player in one or more video frames of the video feed includes: assigning an x, y coordinate values to the player relative to a field of the sporting event; and assigning a time stamp to the x, y coordinate values.

In some aspects, techniques described herein relate to a system, wherein generating the player identification for the player further includes: receiving a set of jersey numbers for each player in the sporting event; identifying an associated number with the player from the video feed, the associated number having an assigned confidence value; determining that the associated number matches an assigned jersey number from the set of jersey numbers; and determining that the confidence value is above a threshold value.

In some aspects, techniques described herein relate to a system, wherein generating the player identification for the player further includes: receiving a set of facial construction data for each player in the sporting event; identifying data of a facial reconstruction of the player from the video feed; and determining that the facial reconstruction of the player matches facial construction data received for the player.

In some aspects, techniques described herein relate to a system, wherein the team formation data includes a positional setup of players on a field of the sporting event.

In some aspects, techniques described herein relate to a system wherein the team formation data is generated, by the computing system, based on exemplary data captured prior to a start of the sports event.

In some aspects, techniques described herein relate to a system, wherein the operations further includes: retrieving event data related to the sporting event, and

based upon the retrieved event data, updating the team formation data dynamically.

In some aspects, techniques described herein relate to a non-transitory computer readable medium configured to store processor-readable instructions, wherein when executed by a processor, the instructions perform operations including: receiving a video feed of a sporting event; capturing, by a computing system, positional data of a player in one or more video frames of the video feed; receiving, by the computing system, team formation data for at least one team in the sporting event, wherein the team formation data includes a player role associated with each player; determining, by the computing system, a correspondence between the positional data of a player and the team formation data; and generating, by the computing system, a player identification for the player, wherein the player identification is based on the correspondence between the positional data for the player and a player role from the team formation data.

In some aspects, techniques described herein relate to a non-transitory computer readable medium, wherein capturing position data of a player in one or more video frames of the video feed includes: assigning an x, y coordinate values to the player relative to a field of the sporting event; and assigning a time stamp to the x, y coordinate values.

In some aspects, techniques described herein relate to a non-transitory computer readable medium, wherein generating the player identification for the player further includes: receiving a set of jersey numbers for each player in the sporting event; identifying an associated number with the player from the video feed, the associated number having an assigned confidence value; determining that the associated number matches an assigned jersey number from the set of jersey numbers; and determining that the confidence value is above a threshold value.

In some aspects, techniques described herein relate to a non-transitory computer readable medium wherein generating the player identification for the player further includes: receiving a set of facial construction data for each player in the sporting event; identifying data of a facial reconstruction of the player from the video feed; and determining that the facial reconstruction of the player matches facial construction data received for the player.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2A is an exemplary flow diagram for identifying a player in a sports event, according to example embodiments.

FIG. 2B is an exemplary flow diagram for an automated data cleaning and manual data cleaning pipeline for data generation, according to example embodiments.

FIG. 3 depicts an exemplary embodiment of a method of identifying a player in a sports event, according to example embodiments.

FIG. 4 depicts an exemplary flow diagram for identifying a player in a sports event, according to example embodiments.

FIG. 5 depicts another exemplary flow diagram for identifying a player in a sports event, according to example embodiments.

FIG. 6 depicts an exemplary table of data mapping for a player in a team formation, according to example embodiments.

FIG. 7A depicts a block diagram of a model architecture including tracks in a game interval, according to example embodiments.

FIG. 7B depicts a block diagram of a model architecture of a training sample, according to example embodiments.

FIG. 7C depicts a block diagram of a frame of the model architecture, according to example embodiments.

FIG. 8 depicts a flow diagram of an exemplary prediction model of a single head prediction for a single team formation, according to example embodiments.

FIG. 9 depicts a flow diagram of an exemplary prediction model of a multi head prediction for a multiple team formation, according to example embodiments.

FIG. 10 depicts an exemplary frame output of the prediction model, according to example embodiments.

FIG. 11 depicts an exemplary graph of model training, according to example embodiments.

FIG. 12 depicts a flow diagram for training a machine-learning model, according to example embodiments.

FIG. 13A is a block diagram illustrating a computing device, according to example embodiments.

FIG. 13B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Various aspects of the present disclosure relate generally to techniques for machine learning for sports applications. For instance, certain aspects include the training of machine learning models and the utilization of computer vision techniques for identifying player role within a specific sports team and/or identification of a specific player.

The terminology used herein may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.” As used herein, the singular forms “a,” “an,” and “the” include plural reference unless the context dictates otherwise.

Other embodiments of the disclosure will be apparent to those skilled in the art from consideration of the specification and practice of the invention disclosed herein. It is intended that the specification and examples be considered as exemplary only.

During a sporting event, players may constantly move around a sporting field. Further, video broadcasts of the sporting events may constantly have players that leave the frame of view. Tracking and properly identifying a player's role based on broadcast information may be valuable. It may be advantageous to auto-identify players' roles live during a sporting event without human-in-the-loop intervention.

Systems and techniques disclosed herein are directed to identifying player positions (e.g., using visual attributes of a video feed) during live sporting events. Such identification may be used for various purposes such as player tracking for sporting events.

According to systems and techniques disclosed herein, in comparison to relying exclusively on spatial and/or visual features (e.g., facial recognition of players or player jersey number), a player's role and/or identification may be determined by positional data (e.g., spatial and temporal data), which provide increased accuracy in predicting a player's role and/or identification where, for example, the system encounters poor video quality, visual occlusion of players, similarities in visual appearance of players, and/or other circumstances that would prevent accurate and complete visual or spatial inspection.

One or more embodiments may incorporate systems and methods of player role identification, which may leverage the structured nature of soccer games, where players adhere to defined roles such as goalie, defender, and forward. These defined roles may provide a clear framework for a machine learning system to determine a prediction. It will be understood that soccer and related roles, attributes, techniques, processes, etc. are provided only as an example such that the techniques disclosed herein may be applicable to any other sport such as any other individual or team sport.

One or more embodiments may incorporate a system that incorporates a recurrent graph neural network to predict player roles based on their 2-dimensional (“2D”) positions on the soccer field. The recurrent graph neural network may capture spatial and temporal patterns of the players to identify their respective roles. The recurrent graph neural network may be configured to construct predefined nodes and relationships and may integrate game lineup data. This may allow the system to automatically map player roles to team details like jersey numbers for accurate identification.

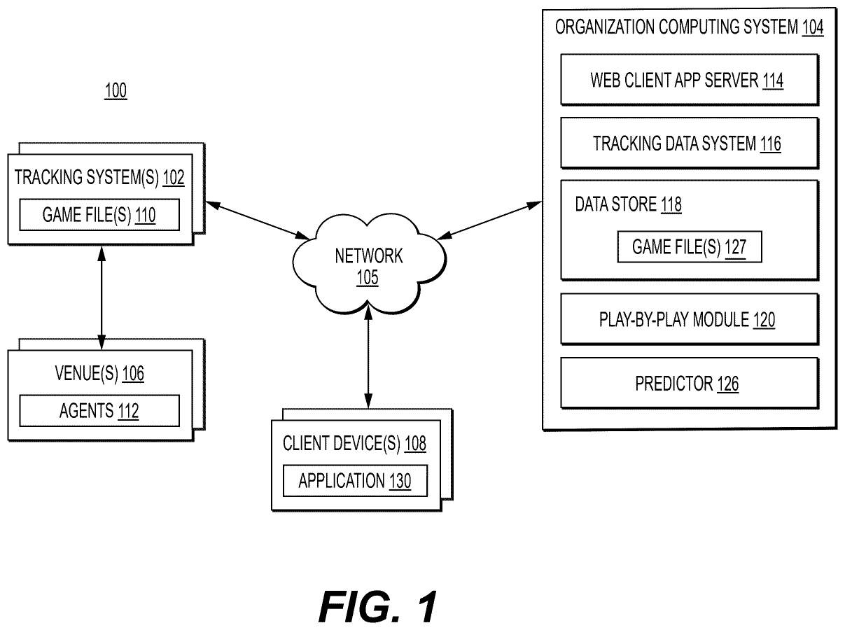

FIG. 1 is a block diagram illustrating a computing environment 100, according to example embodiments. Computing environment 100 may include tracking system 102 (e.g., positioned at or in communication with one or more components positioned at venue 106), organization computing system 104, and one or more client devices 108 communicating via network 105. In an example, environment 100 and its components capture player data (e.g., positional data, temporal data, spatial data, etc.) and compare player data against team formation data, mapping a player to a team role, and generating a player identification for the player, wherein the player identification associates the player with, for example, the player's name/identity. Additionally, environment 100 and its components may utilize ancillary appearance data (e.g., facial recognition, jersey number identification, etc.) to improve prediction confidence for a player role and/or player identification.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106 and/or may be in communication (e.g., electronic communication, wireless communication, wired communication, etc.) with components located at venue 106. For example, venue 106 may be configured to host a sporting event that includes one or more agents 112. Tracking system 102 may be configured to capture the motions of one or more agents (e.g., players) on the playing surface, as well as one or more other agents (e.g., objects) of relevance (e.g., ball, puck, referees, etc.). In some embodiments, tracking system 102 may be an optically-based system using, for example, a plurality of fixed cameras, movable cameras, one or more panoramic cameras, etc. For example, a system of six calibrated cameras (e.g., fixed cameras), which project three-dimensional locations of players and a ball onto a two-dimensional overhead view of the playing surface may be used. In another example, a mix of stationary and non-stationary cameras may be used to capture motions of all agents on the playing surface as well as one or more objects or relevance. Utilization of such a tracking system (e.g., tracking system 102) may result in many different camera views of the playing surface (e.g., high sideline view, free-throw line view, huddle view, face-off view, end zone view, etc.).

In some embodiments, tracking system 102 may be used for a broadcast feed of a given match. For example, tracking system 102 may be used to generate game files 110 to facilitate a broadcast feed of a given match. In such embodiments, each frame of the broadcast feed may be stored in a game file 110. A broadcast feed may be a feed that is formatted to be broadcast over one or more channels (e.g., broadcast channels, internet based channels, etc.). A game file 110 may be converted from a first format (e.g., a format output by the one or more cameras or a different format than the format output by the one or more cameras) and may be converted into a second format (e.g., for broadcast transmission).

In some embodiments, game file 110 may further be augmented with other event information corresponding to event data, such as, but not limited to, game event information (pass, made shot, turnover, etc.) and context information (current score, time remaining, etc.). According to embodiments, event data may be generated manually or may be generated by a computing system in real time (e.g., within approximately 30 seconds of an event occurring), as discussed herein. A computing system may generate the event data by, for example, analyzing tracking data (e.g., from tracking system 102), and/or one or more other data types such as a video feed, excitement data, etc. The computing system may utilize a machine learning model to determine when given tracking data or changes in tracking data (e.g., given player movements, object movements, changes in the same, etc.) correspond to an event (e.g., a scoring event, a penalty event, a possession based event, play type event, etc.). Event data may be automatically identified using a machine learning trained to receive, as an input, a game file 110 or a subset thereof and output game information and/or context information based on the input. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, and/or the like and may include tagged and/or untagged data.

According to embodiments disclosed herein, event data may be generated based on tracking data and/or content feeds (e.g., in-venue video feeds, broadcast feeds, etc.). For example, tracking data may be generated by providing a content feed to one or more machine learning models. The one or more machine learning models may identify players and/or objects in the content feed and convert them to digital representations. The digital representations of the players and/or objects and their respective positions may be tracked to identify tracking data such as movement data (e.g., changes in the positions), changes in movement, trends, etc. Such information may be used by a prediction module to make predictions. The tracking data may be analyzed by the machine learning models to determine correlations between the tracking data and event types (e.g., goal scored, pass made, play types, etc.). For example, tracking data may be used to determine when a digital representation of an object (e.g., a ball) crosses a scoring object (e.g., a goal post). Based on such determination, an event type of a goal scored may be identified. Further, the digital representation of the player(s) that contacted the object (e.g., ball) prior to the goal scored event may be identified as the player(s) that contributed to or otherwise caused the event (e.g., goal). Accordingly, content feeds may be used to generate tracking data which may further be used to determine event data corresponding to certain sports events.

Tracking system 102 may be configured to communicate with organization computing system 104 via network 105. For example, tracking system 102 may be configured to provide organization computing system 104 with a broadcast stream of a game or event in real-time or near real-time via network 105. As an example, tracking system 102 may provide one or more game files 110 in a first format (e.g., corresponding to a format based on the components of tracking system 102). Alternatively, or in addition, tracking system 102 or organization computing system 104 may convert the broadcast stream (e.g., game files 110) into a second format, from the first format. The second format may be based on the organization computing system 104. For example, the second format may be a format associated with data store 118, discussed further herein.

Organization computing system 104 may be configured to process the broadcast stream of the game. Organization computing system 104 may include at least a web client application server 114, tracking data system 116, data store 118, play-by-play module 120, and/or prediction module 126. Each of tracking data system 116, play-by-play module 120, and prediction module 126 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of the instructions.

Tracking data system 116 may be configured to receive broadcast data from tracking system 102 and generate tracking data from the broadcast data. In some embodiments, tracking data system 116 may apply an artificial intelligence and/or computer vision system configured to derive player-tracking data from broadcast video feeds.

To generate the tracking data from the broadcast data, tracking data system 116 may, for example, map pixels corresponding to each player and ball to dots and may transform the dots to a semantically meaningful event layer, which may be used to describe player attributes. For example, tracking data system 116 may be configured to ingest broadcast video received from tracking system 102. In some embodiments, tracking data system 116 may further categorize each frame of the broadcast video into trackable and non-trackable clips. In some embodiments, tracking data system 116 may further calibrate the moving camera based on the trackable and non-trackable clips. In some embodiments, tracking data system 116 may further detect players within each frame using skeleton tracking. In some embodiments, tracking data system 116 may further track and re-identify players over time. For example, tracking data system 116 may reidentify players who are not within a line of sight of a camera during a given frame. In some embodiments, tracking data system 116 may further detect and track an object across a plurality of frames. In some embodiments, tracking data system 116 may further utilize optical character recognition techniques. For example, tracking data system 116 may utilize optical character recognition techniques to extract score information and time remaining information from a digital scoreboard of each frame.

Such techniques assist in tracking data system 116 generating tracking data from the broadcast feed (e.g., broadcast video data). For example, tracking data system 116 may perform such processes to generate tracking data across thousands of possessions and/or broadcast frames. In addition to such process, organization computing system 104 may go beyond the generation of tracking data from broadcast video data. Instead, to provide descriptive analytics, as well as a useful feature representation for prediction module 126, organization computing system 104 may be configured to map the tracking data to a semantic layer (e.g., events).

Tracking data system 116 may be implemented using a machine learning model. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, historical or simulated feature representations, and/or the like and may include tagged and/or untagged data. The tagged data may include position information, movement information, object information, trends, agent identifiers, agent re-identifiers, etc.

Play-by-play module 120 may be configured to receive play-by-play data from one or more third party systems. For example, play-by-play module 120 may receive a play-by-play feed corresponding to the broadcast video data. In some embodiments, the play-by-play data may be representative of human generated data based on events occurring within the game. Even though the goal of computer vision technology is to capture all data directly from the broadcast video stream, the referee, in some situations, is the ultimate decision maker in the successful outcome of an event. For example, in basketball, whether a basket is a 2-point shot or a 3-point shot (or is valid, a travel, defensive/offensive foul, etc.) is determined by the referee. As such, to capture these data points, play-by-play module 120 may utilize machine learning outputs and/or manually annotated data that may reflect the referee's ultimate adjudication. Such data may be referred to as the play-by-play feed.

To help identify events within the generated tracking data, tracking data system 116 may merge or align the play-by-play data with the raw generated tracking data (which may include the game and time fields). Tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, tracking data system 116 may be configured to perform various operations on the aligned tracking system. For example, tracking data system 116 may use the play-by-play data to refine the player and ball positions and precise frame of the end of possession events (e.g., shot/rebound location). In some embodiments, tracking data system 116 may further be configured to detect events, automatically, from the tracking data. In some embodiments, tracking data system 116 may further be configured to enhance the events with contextual information.

For automatic event detection, tracking data system 116 may include a neural network system trained to detect/refine various events in a sequential manner. For example, tracking data system 116 may include an actor-action attention neural network system to detect/refine one or more of: shots, scores, points, rebounds, passes, dribbles, penalties, fouls, and/or possessions. Tracking data system 116 may further include a host of specialist event detectors trained to identify higher-level events. Exemplary higher-level events may include, but are not limited to, plays, transitions, presses, crosses, breakaways, post-ups, drives, isolations, ball-screens, offside, handoffs, off-ball-screens, and/or the like. In some embodiments, each of the specialist event detectors may be representative of a neural network, specially trained to identify a specific event type. More generally, such event detectors may utilize any type of detection approach. For example, the specialist event detectors may use a neural network approach or another machine learning classifier (e.g., random decision forest, SVM, logistic regression etc.).

While mapping the tracking data to events enables a player representation to be captured, to further build out the best possible player representation, tracking data system 116 may generate contextual information to enhance the detected events. Exemplary contextual information may include defensive matchup information (e.g., who is guarding who at each frame, defensive formations), as well as other defensive information such as coverages for ball-screens or presses.

In some embodiments, to measure influence, tracking data system 116 may use a measure referred to as an “influence score.” The influences score may capture the influence a player may have on each other player on an opposing team on a scale of 0-100. In some embodiments, the value for the influence score may be based on sport principles, such as, but not limited to, proximity to player, distance from scoring object (e.g., basket, goal, boundary, etc.), gap closure rate, passing lanes, lanes to the scoring object, and the like.

The computing system 104 may further include a padding module that may be configured to create new player representations using mean-regression to reduce random noise in the features. For example, one of the profound challenges of modeling using potentially only limited games (e.g., 20-30 games) of data per player may be the high variance of low frequency events seen in the tracking data. Therefore, padding module may be configured to utilize a padding method, which may be a weighted average between the observed values and sample mean.

Accordingly, for each player, tracking data system 116, play-by-play module 120, and padding module may work in conjunction to generate a raw data set and a padded data set for each player.

The prediction module 126 may include one or more machine-learning models. The prediction module 126 may utilize one or more video feeds to identify positional (e.g., spatial and temporal) data for each player and determine the player's role based on a comparison to team formation data for each team. For example, machine learning models may be trained utilizing positional data (e.g., spatial and temporal data) and team formation data for a plurality of players according to a plurality of team formations for a team. The prediction module 126 may thus accurately predict a player's role (and, in turn, identification) based on the positional data for a player and the team formation data for the player's associated team. Similarly, the prediction module 126 may be used to predict and select team formation data for a team based, for example, on reference data and/or team formation data from previous or preexisting sports event data.

As discussed herein, one or more machine learning models may be trained to understand a sports language. Accordingly, machine learning models disclosed herein are sports machine learning models. Such sports machine learning models may be trained using sports related data (e.g., tracking data, event data, etc., as discussed herein). A sports machine learning model trained to understand a sports language based on sports related data may be trained to adjust one or more weights, layers, nodes, biases, and/or synapses based on the sports related data. A sports machine learning model may include components (e.g., a weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine learning model may correlate sports information and statistics in a competitive landscape. A sports machine learning model may be trained to adjust one or more weights, layers, nodes, biases, and/or synapses to associate certain sports statistics in view of a competition landscape. For example, a win indicator for a given team may automatically be correlated with a loss indicator for an opposing team. As another example, a score static may be considered a positive attribution for a scoring team and a negative attribution for a team being scored upon. As another example, a given score may be ranked against one or more scores based on a relative position of the score in comparison to the one or more other scores.

A sports machine learning model may be trained based on sports tracking and/or event data, as discussed herein. Such data may include player and/or object position information, movement information, trends, and changes. For example, a sports machine learning model may be trained by modifying one or more weights, layers, nodes, biases, and/or synapses to associate given positions in reference to the playing surface of venue and/or in reference to none or more agents. As another example, a sports machine learning model may be trained by modifying one or more weights, layers, nodes, biases, and/or synapses to associate given movement or trends in reference to the playing surface of venue and/or in reference to none or more agents. As another example, a sports machine learning model may be trained by modifying one or more weights, layers, nodes, biases, and/or synapses to associate sporting events with corresponding time boundaries, teams, players, coaches, officials, and environmental data associated with a location of corresponding sporting events.

A sports machine learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine learning model may be trained in view sports targets, play outcomes, player positions, and/or the like associated with a given sport (e.g., soccer, American football, basketball, baseball, tennis, golf, rugby, hockey, a team sport, an individual sport, etc.). For example, a soccer based sports machine learning model may be trained to correlate or otherwise associate player position information in reference to a soccer pitch. The soccer based sports machine learning model may further be trained to correlate or otherwise associate sports data in reference to a number of players and sports targets specific to soccer.

According to aspects, one or more given sports machine learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, a sports machine learning model may receive inputs including sports data for a given sport and may generate a matrix representation based on features of the given sport. The sports machine learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine learning model may perform operations based on the generated matrix. The features may be updated based on input data or updated training data based on, for example, sports data associated with features that the model is not previously trained to associate with the given sport. Accordingly, sports machine learning models may be iteratively trained based on sports data or simulated data.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as generative learning, linear regression, logistic regression, random forest, gradient boosted machine (GBM), deep learning, graphical neural network (GNN), and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity

Data store 118 may be configured to store one or more game files 127. Each game file 127 may include video data of a given match. For example, the video data may correspond to a plurality of video frames captured by tracking system 102, the tracking data derived from the broadcast video as generated by tracking data system 116, play-by-play data, enriched data, and/or padded training data. Game files 127 may be based, for example, on game files 110 as discussed herein. Game files 127 may be in a different format than game files 110. For example, a first format of game files 110 or a subset thereof may be transformed into a second format of game files 127. The transformation may be performed automatically based on the type and/or content of the first format and the type and/or content of the second format.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 130. Application 130 may be representative of a web browser that allows access to a website or a stand-alone application. Client device 108 may access application 130 to access one or more functionalities of organization computing system 104. Client device 108 may communicate over network 105 to request a webpage, for example, from web client application server 114 of organization computing system 104. For example, client device 108 may be configured to execute application 130 to receiving predictions of players' roles from the prediction module 126. The content that is displayed to client device 108 may be transmitted from web client application server 114 to client device 108, and subsequently processed by application 130 for display through a graphical user interface (GUI) of client device 108.

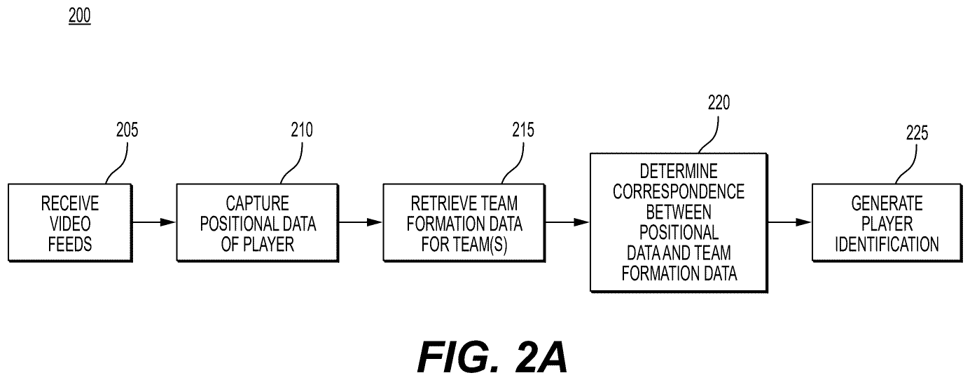

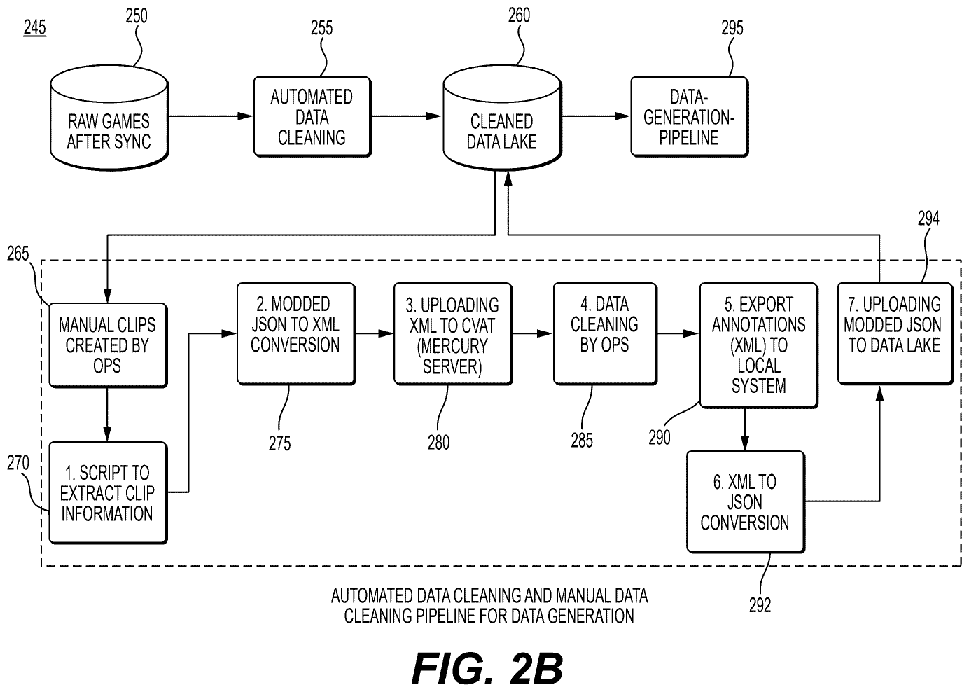

FIG. 2A is an exemplary flow diagram 200 for identifying a player in a sports event, according to example embodiments. The method of FIG. 2A may be implemented by environment 100 of FIG. 1.

Step 205 may include receiving a video feed of a sporting event. The video feed may be received via one or more cameras located at or within venue 106, and additionally or alternatively, the video feed(s) may be received from a broadcast feed that is accessed, for example, via a network 105, a local data store, or similar communications means. The video feed(s) may include additional data and/or additional associated data types, including tracking data from tracking system 102, temporal and spatial positioning data for players, team formation data, or other data received from the video feed or resulting from preprocessing of the video feed. The sporting event may be a soccer game.

Step 210 may include capturing, by a computing system (e.g., computing system 104), positional data of a player in one or more video frames of the video feed. This may include assigning an x, y coordinate values to the player relative to a field of the sporting event; and assigning a time stamp to the x, y coordinate values. This may be determined based on positional data received at step 205. According to one embodiment, the positional data includes spatial data for a player (including, for example, location/spatial/coordinate data for a player and/or spatial relationships between players) and temporal data/features of a player, including, for example, motion and/or behavior data for a player over a time period. For example, such motion and/or behavior data may be generated and processed for a player over a period of time, including, for example, multiple sports games or periods within a sports game. The spatial data and temporal data may be generated and processed by computing system 104 based on, for example, data generated and processed by tracking system 102 and/or from historical data accessed via network 105 or stored locally. The positional data may be in reference to, for example, a playing surface of venue 106 and/or a normalized or translated version of the playing surface of venue 106. Feature data may include player roles, jersey numbers, team affiliations, 2D x-y coordinates of players, and player movement tracks.

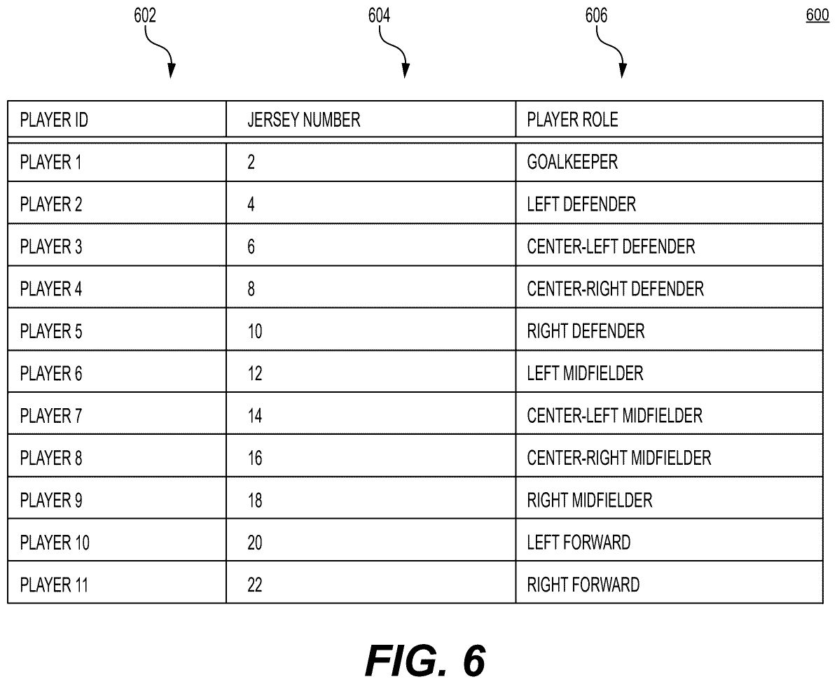

Step 215 may include receiving, by the computing system, team formation data for at least one team in the sporting event, wherein the team formation data includes a player role associated with each player. According to one embodiment, the team formation data may include the positional setup of players on the field, where such team formation data may be utilized to enhance the spatial awareness of a player and between players. Team formations may be based upon particular game strategies and may be game specific. For example, in the context of a soccer game with eleven players per team, a positional setup might include one goalkeeper, four defenders, four midfielders, and two forwards (e.g., a 4-4-2 formation). Similarly, a soccer team's positional setup might include one goalkeeper, four defenders, three midfielders, and three forwards (e.g., a 4-3-3 formation). Team formation data may thus include the positional setup for a specific team, wherein a player identity is mapped to each player role/position. FIG. 6 provides an example of a portion of team formation data for a team utilizing a 4-4-2 formation. The formation data may be in reference to, for example, a playing surface of venue 106 and/or a normalized or translated version of the playing surface of venue 106. Some common formation may include 4-3-3, 4-2-3-1 and 4-4-2, 3-4-2-1, 3-5-2, and 4-4-1-1.

According to one embodiment, team formation data for each team may be stored and retrieved based on previous sports event data or based on a central database or data store for each team's formation data, where the data may be stored and accessed locally or offline, or it may be stored and accessed via network 105. Similarly, team formation data for each team may be stored as the output of machine learning models for each team and/or for each team formation associated with each team.

According to one embodiment, the team formation data may include a comprehensive set of team formations representing various formations of a specific team. During configuration, this team formation data may be utilized by the computing system 104 or by a human operator to assign a team formation for each team, or alternatively or additionally, continuously throughout the sports event. Similarly, player role data, player identification data, and/or player positional data for each player may be stored and accessed for comparison to team formation data for purposes of predicting a player role and/or player identification. For example, player role data and associated player identification data may be stored in association with one or more team formation datasets for a specific team. For example, and as shown in FIG. 6, stored data for player 2 may indicate player 2's player role as Left Defender when team formation data indicates a 4-4-2 formation for a specific team, wherein such data may be updated prior to, at the start of, or continuously and dynamically throughout a sports event.

According to one embodiment, a human operator may manually input team formation data for each team in a sports event. According to another embodiment, a formation machine learning model may be trained to classify positions of players as known formations. The known formations may be selected from a plurality of formations that are provided to the formation machine learning model as training data. The formation machine learning model may be trained based on historical or simulated video data that may be tagged as having one or more formations. The formation machine learning model may receive, as an input, a video stream of a sporting event. The formation machine learning model may output a formation that most correlates with a known formation (e.g., if a correlation threshold is met). Accordingly, the team formation data for one or more teams may be determined based on historical video feeds of sporting events associated with the one or more teams. A plurality of formation data for the one or more teams may be stored at a databased and accessed at step 215

Step 220 may include determining, by the computing system (e.g., by prediction module 126), a correspondence between the positional data of a player and the team formation data. The correspondence between the positional data of the player and the team formation data may be determined by a graph recurrent neural network (e.g., the graph neural network of the prediction module 126). This may include assigning a value to the correspondence by the graph recurrent neural network. This value may be compared to a threshold value to determine whether a player should be mapped to a team formation in the next step (i.e., step 225).

For example, at step 220, a current formation of the team may be determined (e.g., by the formation machine learning model). The current formation may be determined from the plurality of formation data for the team associated with the player or one or more teams associated within the sporting event.

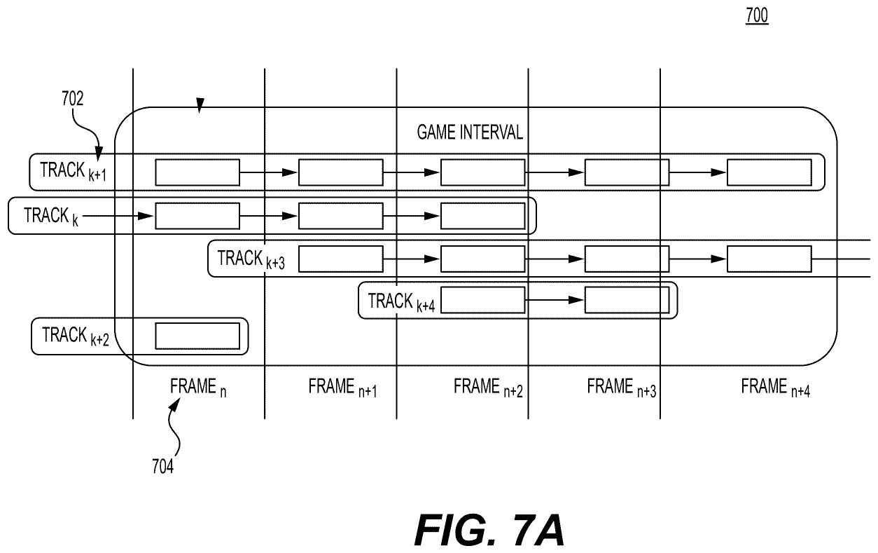

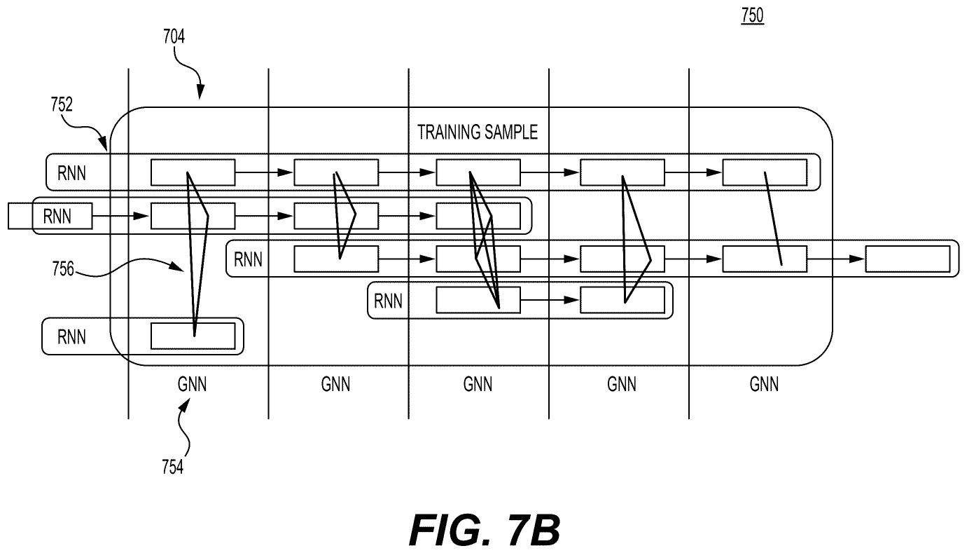

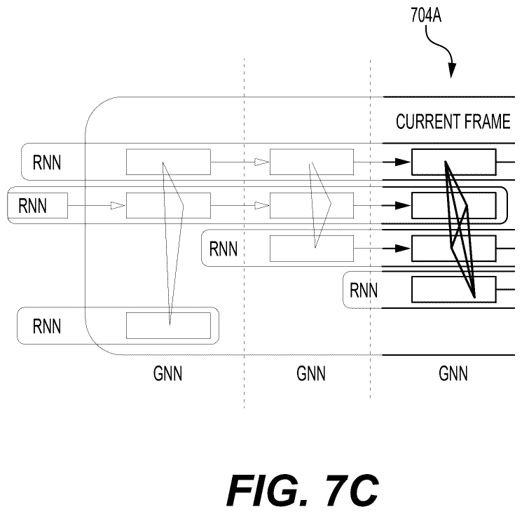

Step 220 may include assigning the identified player from step 210 to a particular node in the graph neural network. For example, a fully connected graph (e.g., within the graph neural network) may be created for each frame, where each detected player is assigned a node index dynamically based on their detection order within the frame. Edges may connect all players detected in the same frame, forming a fully connected graph as depicted in FIG. 7B below.

Step 225 may include generating, by the computing system (e.g., by prediction module 126), a player identification for the player, wherein the player identification is based on the correspondence between the positional data for the player and a player role from the team formation data. In some examples, the player identification may identify the player's name, jersey number, or other data associated with the player. The player identification may then be cached/saved for future reference.

In some examples, step 225 may include mapping a player role to the player, based on the correspondence between the positional data of a player and the team formation data, wherein the player role may then be mapped to the player identity to generate the player identification for the player.

In some examples, the method of FIG. 2A may be applied across all frames of a video feed in a sporting event. For each frame, a player association may be determined by implementing the steps discussed herein. Each player association in each frame may be saved for future reference during the sporting event. This may allow for the system to rely on previous identifications when a new player identification has a low confidence value as discussed in greater detail below.

According to one embodiment, in order to generate a player identification for a player, there may be a threshold level of confidence that must be satisfied with respect to the correspondence between the positional data and the team formation data. If the threshold is not met, the player may be unidentified, or if the player was previously identified, the player may be assigned this previous identification. Additionally, or alternatively, system environment 100 may utilize visual recognition (e.g., facial appearance) and/or identifier recognition (e.g., jersey number recognition) as an additional means of confirming the player identification generated for a specific player or as an additional means of satisfying the threshold level of confidence. Accordingly, a level of confidence determined based on positional data and/or the team formation data may be augmented based on a visual recognition, to determine whether the threshold level of confidence is reached.

According to one embodiment, the method utilizes machine learning methods and/or computer vision methods applied to exemplary team formation data and/or positional data of a player to capture and update a player role and/or player identification from stable and/or high-confidence matches with team formation data and/or positional data of a player during a sports event, enabling adaptation to varying conditions in a sports event. Alternatively, or additionally, a human operator may dynamically update the team formation data and/or positional data of a player based on visual matching of a player identification and/or changes to team positions/team formations during a sports event.

According to one embodiment, the player identification may be utilized to track a player throughout a sports event, including after periods in which the player does not appear on a video/broadcast feed or is visually occluded from view in a video/broadcast feed. Player identification data may be utilized to identify such gaps/visual occlusions in the video/broadcast feed and to mark such portions of the video/broadcast feed for automated or manual correction or updating. Player identification data may be used to more efficiently re-identify a player following such visual gaps/occlusions in the video/broadcast feed. For example, where a video/broadcast feed includes multiple cameras, player identification data may be utilized to track a player across the view from multiple cameras, where a player may be missing/occluded from view in a specific camera's viewing area.

According to one embodiment, the player identification may be utilized in providing a player track for a specific player, wherein the player track is included with tracking information for the player. The player track may provide player identification as well as position information and/or role information. The player track may be, for example, a packet included in a tracking data feed.

According to one embodiment, the player identification may be utilized in connection with displaying player information, including for example, name, jersey number, biographical data, news stories, etc., where such player-associated information may be overlaid on video/broadcast feed to provide information associated with the player identification.

According to one embodiment, the player identification may be utilized in determining game stats associated with a specific player in a sports game. Where the system environment 100 identifies and detects sports events in a sports game (e.g., goal scored, pass, assist, steal, penalty, substitution, etc.), the player identification data may be utilized to associate one or more sports events with a specific player. Similarly, player identification may be used to record a player track through a game associated with a specific player, wherein such player track may be utilized in recording player-specific stats, including for example, distance run, time-in-motion, time at rest, etc.

According to one embodiment, the method may run continuously or iteratively during a sports event to continuously update player identification based on stable and/or high confidence matches for a player's identification. Player identification may be updated based on such continuous or iterative operation. It will be understood that a player with a known player identification may no longer be associated with the known player identification (e.g., due to occlusion of the player in a video feed, based on the player being off camera in a video feed, etc.). In such scenarios, the player may be identified again in accordance with techniques discussed herein.

FIG. 2B is an exemplary flow diagram 245 for an automated data cleaning and manual data cleaning pipeline for data generation, according to example embodiments. The method of FIG. 2B may be implemented by environment 100 of FIG. 1. The flow diagram 245 may illustrate a process utilized on a set number of sporting events (e.g., hundreds of games, thousands of games, etc.) to generate a training and/or validation dataset for a player identification model, utilizing new raw tracking data. For example, this method may provide a process for generating training data for the prediction module 126.

According to one embodiment, automated data cleaning may be used to automatically clean and improve the raw data quality where, for example, it may improve the data in the following areas: assigning untracked and/or missing players to tracks (or other tracking data) utilizing algorithmic methods (e.g., Hungarian algorithm); smoothing the tracklet for jersey number and/or player identification utilizing majority voting methods; and/or increasing the track lengths and/or durations by interpolating missing frame data in track(s), if any. According to systems and techniques disclosed herein, such automated data cleaning of raw data may, for example, improve the player identification model accuracy by 2%-3% or greater.

According to one embodiment, manual data cleaning may also be used to improve the quality of a dataset and/or to create a validation dataset of the player identification model. Similarly, manual data cleaning may also be used to create and/or improve the dataset for challenging identification/tracking scenarios (e.g., occluded player views, multiple players crowded in a small area) where player identification models may generally have difficulty in accurately predicting a player identification.

At step 250 raw game data may be received after syncing. This may include receiving a video feed of a sporting event. The raw data may correspond to particulars frame of the video feed. The raw data may include two dimensional pitch locations, track numbers, team identity (home, away, or referee), jersey numbers, and other player metadata. At step 255, an automated data cleaning is performed on the raw game data, and the data subsequently enters a cleaned data lake 260, wherein steps 265-294 may be performed. Data cleaning may include applying a series of enhancement algorithms to improve the accuracy and generated refined tracking information. These enhancement algorithms may include (1) assigning an existing track to previously untracked players; (2) interpolating tracks to fill in missing player locations, if any; (3) ensuring that each track is consistently associated with a single jersey number, and (4) stitching tracks together to extend a player's tracking duration. Each of the algorithms may occur at step 255 and/or step 285 discussed below. At step 265, clips of a match may be created. These may be created manually or using one or more machine learning models. At step 270, a script may be run to extract information from one or more clips. At step 275, a first data file (e.g., a JSON file) may be converted to a second data file (e.g., an Extensible Markup Language (XML) data file). At step 280, the second data file (e.g., XML data file) may be uploaded to a Computer Vision Annotation Tool (CVAT), and at step 285, the data may be further cleaned by performing data validation, removing duplicates, handling missing data, performing transformations on data, and detecting errors in the data. At step 290, annotations in the second data file format (e.g., XML format) may be exported to a local system, and at step 292, the second data file (e.g., XML file) may be modified to a first file type (e.g., JSON) conversion. At step 294, the modified file (e.g., JSON file) may be uploaded to the cleaned data lake 260, and at step 295, the data may then enter the data-generation pipeline. This may be utilized for training at a later time.

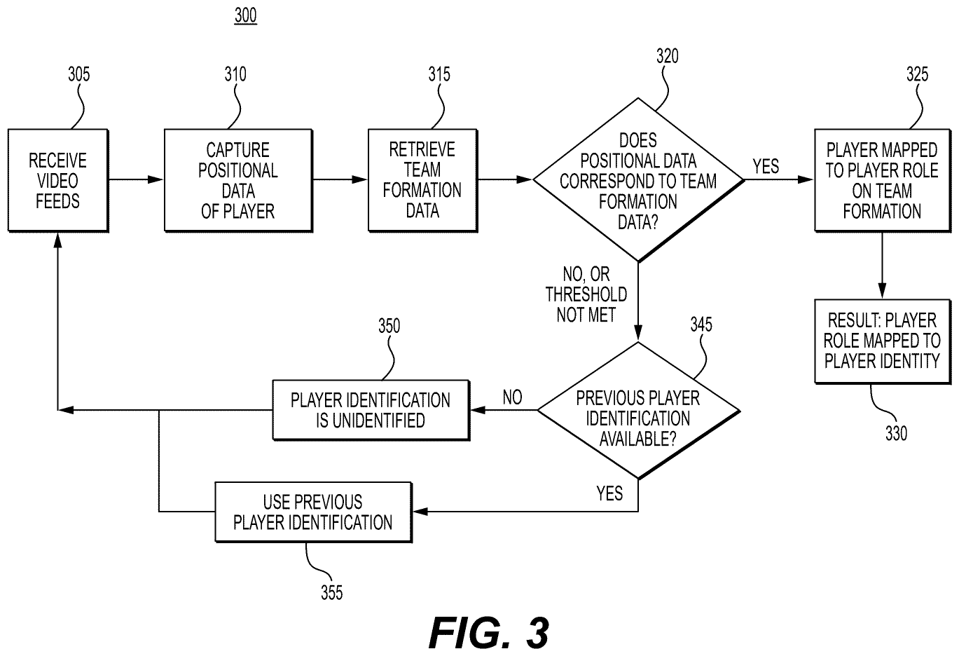

FIG. 3 depicts an exemplary flowchart 300 of a method of identifying a player in a sports event, according to example embodiments. The method of FIG. 3 may be implemented by environment 100 of FIG. This method may depict an exemplary embodiment of the method described in FIG. 2A.

At step 305, one or more video feeds may be received for a sports event. At step 310, the positional data for a player may be captured from at least one video frame of the one or more video feeds. At step 315, team formation data may be retrieved, including player role data for each player on a team, which may be dependent upon the formation being employed by the team (e.g., for soccer, 4-4-2, 4-3-3, etc.)

At step 320, the positional data for the player may be compared to the team formation data to determine whether a threshold level of correspondence is met between positional data of a player and team formation data. For example, this may be done by the prediction module 126. This may be done implementing the techniques discussed at step 220. For example, during the inference of player associations, the predicted player identify and role may be cached for each player across each frame.

At step 325, if a threshold level of correspondence is met between positional data of a player and team formation data, the player is mapped to a player role on the team formation, wherein such mapping may be based on the positional data of the player. For example, and as shown in FIG. 6, where positional data of a player corresponds sufficiently to the “Left Defender” player role of the team formation data, the player may be mapped to this player role on the team formation. At step 330, the player role may then be mapped to a player identity. For example, and as shown in FIG. 6, when the player has been mapped to a “Left Defender” player role, a player identification of “PLAYER 2” may be generated for the player.

At step 345, a threshold level of correspondence between positional data and team formation data may not be met. In these scenarios, a previous player identification for the identified player from step 310 may be searched for. For example, retrieved player identification from previous player identification may be searched for.

At step 350, if a previous player identification is unavailable for a player, the player may not receive a player identification, and the method may proceed to the next or a subsequent iteration of the method. For example, the next or a subsequent video frame of a video feed is received at step 305 to proceed to a subsequent iteration of the method.

At step 355, if a previous player identification is available for the player, the previous player identification is utilized, and the player has a role mapped to the previous player identification. The method may proceed to the next or a subsequent iteration of the method. For example, the next or a subsequent video frame of a video feed is received at step 305 to proceed to a subsequent iteration of the method.

It will be appreciated by one of ordinary skill in the art that following step 330 of FIG. 3, the method may proceed to the next or a subsequent iteration of the method, wherein the positional data of a player and/or team formation data may be automatically and dynamically updated to reflect improved and/or varying conditions in the sports event (e.g., improved video feed/frame quality, improved lighting conditions, game events including substitutions/red cards, or other data inputs that may inform the method steps).

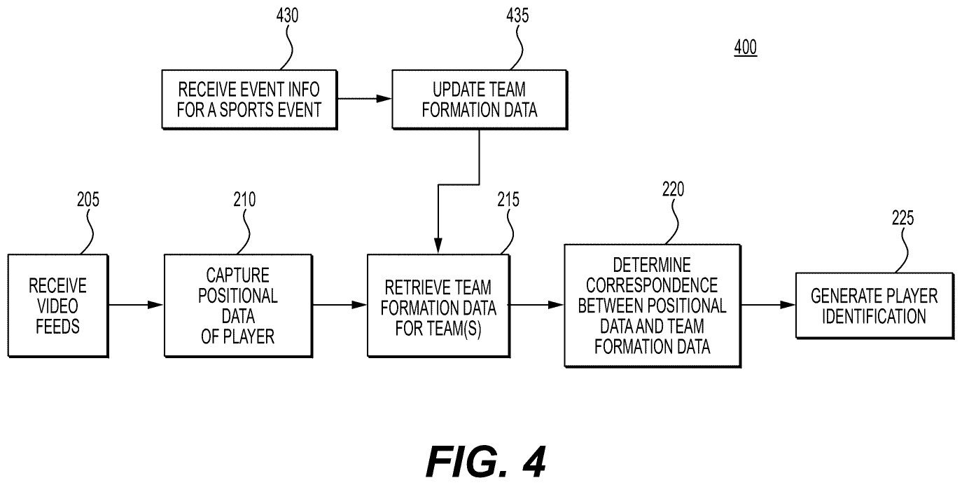

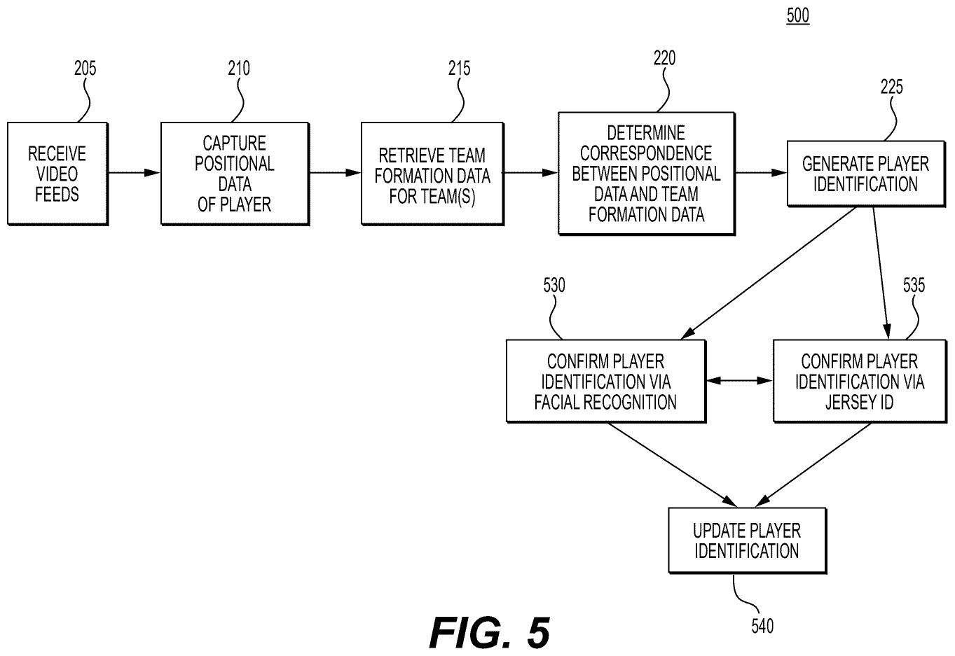

It will be further be appreciated by one of ordinary skill in the art that the flowchart of FIG. 3 may be adapted to alternative embodiments, including for example, the embodiments of FIGS. 4-5.

FIG. 4 depicts an exemplary flow diagram 400 for identifying a player in a sports event, according to example embodiments. The method of FIG. 4 may be implemented by environment 100 of FIG. 1. This method may depict an exemplary embodiment of the method described in FIG. 2A, with additional steps.

For example, the method of FIG. 4 may be applied during the middle of the sporting events. The method the system described herein may react and dynamically update throughout a sporting event. For example, it may reflect how the system may react when a formation changes during a game.

During the sporting event of step 205, an action may occur that may alter the formation of one or more teams in the sporting event. For example, a player substitution may occur, a red card/ejection may occur, or a team may update a formation. This may be received by the system described here through event data at step 430. For example, a substitution on red card recorded may be uploaded as event data.

At step 435, the system may update the saved formation data based on the received event data. For example, if there is a substitution, the player information may be updated. If a red card occurs, the formation may be updated to remove the rejected player.

Next, when the method of FIG. 2A is applied, the system may retrieve the updated information from step 435. This may allow for the method to be applied to the most up to date information.

FIG. 5 depicts another exemplary flow diagram 500 for identifying a player in a sports event, according to example embodiments. The method of FIG. 5 may be implemented by environment 100 of FIG. This method may depict an exemplary embodiment of the method described in FIG. 2A, with additional steps.

FIG. 5 may implement steps 205 through 225 as described above. Next, additional steps may be applied to verify a player's identification through facial recognition or jersey identification.

Step 530 may include identifying data of a facial reconstruction of the player from the video feed; and determining that the facial reconstruction of the player matches facial construction data received for the player. Matching may include being assigned a numerical value above a threshold value.

Step 535 may include receiving a set of jersey numbers for each player in the sporting event; identifying an associated number with the player from the video feed, the associated number having an assigned confidence value; determining that the associated number matches an assigned jersey number from the set of jersey numbers; and determining that the confidence value is above a threshold value.

At step 540 may include, if both threshold values are achieved from step 530 and 535, updating the player identification. In some examples, only one of the threshold values from steps 535 or 530 may need to be achieved to update the player identification.

FIG. 6 depicts an exemplary table 600 of data mapping for a player in a team formation, according to example embodiments. The table includes player IDs 602, jersey numbers 604, and player roles 606. For example, the player role of “Left Defender” is mapped to the player identification of “Player 2”, and it is also mapped to Jersey Number 4. Such information may be used where the system environment 100 utilizes positional data to identify a player role for a particular player, which may then be utilized to generate a Player ID for that particular player.

FIG. 7A depicts a block diagram 700 of a model architecture including tracks 702 in a game interval, according to example embodiments. This model architecture may display how data is uploaded to the prediction module 126. The block diagram may display how tracks 702, representing players within an exemplary sporting event, may be visible at particular frames throughout a game interval of a sporting event. When a player is visible in a frame 704, then the respective track 702 may be displayed within the frame 704. This graph may demonstrate how players exit and enter the frame throughout a sporting event. For example, in Frame n+2, as four tracks are present, this may represent that four players are present in the respective frame of the sporting event. For example, as a game is broadcast, based on camera view, imputed tracks, and the reappearance of players, the tracks 702 may be updated. A time-bordered interval may have a variable number of tracks, each representing a variable length, where the length may be based upon how long a player stays in frame.

FIG. 7B depicts a block diagram 750 of a model architecture of a training sample, according to example embodiments. The present system environment 100 (e.g., via the prediction module 126) utilizes a fusion of 754 Graph Neural Networks (GNNs) and 752 Recurrent Neural Networks (RNNs) into a unified Graph Recurrent Neural Network (GRNN) as a powerful solution for recognizing the player role of a player, which in turn, may be utilized to generate a player identification for the player. Such GNNs 754 may capture the spatial structure of data (e.g., frames), for example, representing positional and/or locational relationships between players and how the players are arranged and/or moving on the field of play, which may be captured in a coordinate system. This spatial awareness may be used to determine the context in which players operate, thus providing insights into team formations and player interactions. RNNs may complement the spatial information of GNNs by utilizing the temporal dimensions (i.e., tracklets) of player data, including for example, how the players moved in certain time periods, allowing for a nuanced analysis of player movements over time.

The block diagram 750 shows how the GNN 754 (e.g., of the prediction module 126) may enable temporal memory for recognizing players and may be trained on the reappearance of the players. This may allow the GNN 754 to build a memory for each player, and to learn a player tracking, space, and zone that particular players have an affinity for within a particular formation. This may be represented by connections 756 shown between the RNNS 752. For example, the frame n+2 displays that four nodes are present, and each node is connected to every other node through connections. The model may be configured to generate real time prediction with constant time inference. The model may only keep in memory hidden states form the previous tracklet frames as represented by connections 756.

FIG. 7C depicts a block diagram of a frame of the mod architecture, according to example embodiments. This may demonstrate an exemplary frame 704A, displaying the connection 756 determined by the model.

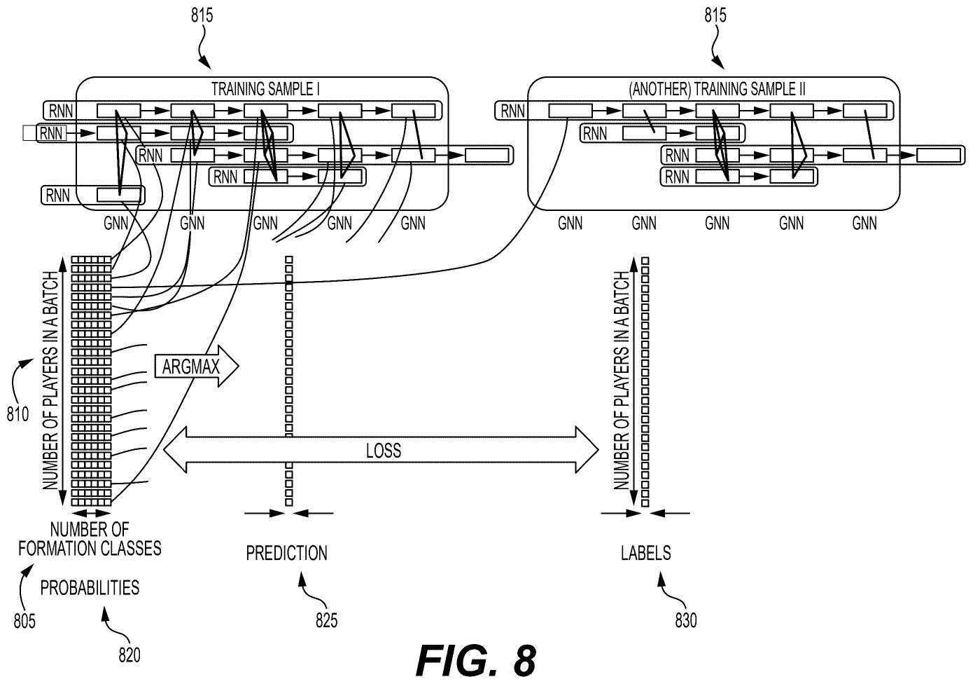

FIG. 8 depicts a flow diagram 800 of an exemplary prediction model of a single head prediction for a single team formation, according to example embodiments.

Training samples 815 may be utilized in generating a number of predictions for a given player representing, for example, probabilities for eleven different player roles and/or player identities. A number of formation classes 805 may be displayed, with each class represented by the vertical column, wherein the number of formation classes may represent the number of player roles in any given team formation (e.g., for any given team formation, there may be eleven different roles with a single role for each player in a team). A number of players 810 in a batch may be displayed, with the number of players represented by the horizontal row.

Team formation data may also be utilized, where such team formation data encapsulates the positional and/or relationship setup of players on the field. The learning model may incorporate distinct prediction heads for each team formation/configuration. These prediction heads may be attuned to the unique characteristics of the given team formation/configuration and the underlying attributes, thus optimizing the model's accuracy in identifying player roles (and players) in this specific framework.

Based on, for example, the positional and temporal data of players, the system environment 100 may generate a prediction 825 of a player role for at least one player, wherein the prediction 825 is generated from a single probability head 820.

The label 830 includes the correct head indices (e.g., correct player role identification) and may be utilized to analyze a difference between the prediction 825 and the label 830 data sets for purposes of training the model.

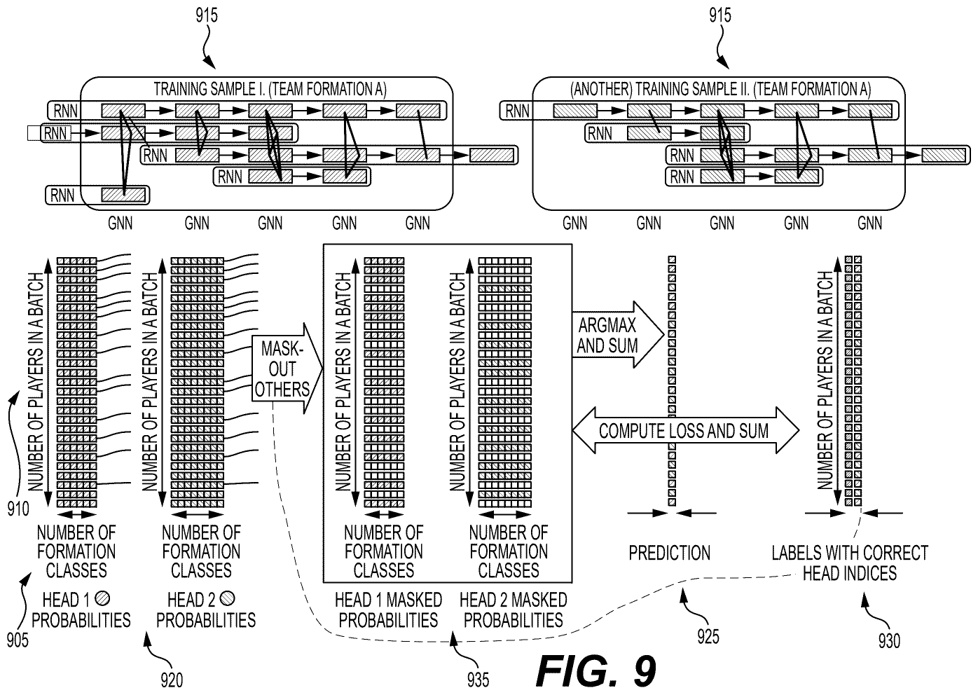

FIG. 9 depicts a flow diagram of an exemplary prediction model of a multi head prediction for a multiple team formation, according to example embodiments. In this example, a two-element batch of training samples may be displayed.

The system environment 100 may also configured to adapt to different team formations, wherein it may employ distinct prediction heads 920 for each configuration. The context-aware predictions (e.g., player role) generated by this approach may provide a better understanding of player dynamics based on the specificities of each sports event/match. Accordingly, this approach incorporates spatial data and temporal data, but may also utilize visual features and event data, as discussed, for example, with respect to FIGS. 4-5.

Training samples 915 may be utilized in generating a number of prediction heads representing probabilities for each formation. For example, two different probability heads 920 (i.e., Head 1 and Head 2) are shown, wherein the plurality of heads represent different team formations. A number of formation classes 905 are shown, with each class represented by the vertical column. A number of players 910 in a batch are shown, with the number of players represented by the horizontal row.

Based on, for example, the probability heads 920, head-1 masked probabilities 935 may be created by masking/removing players belonging to other heads/team formations (e.g., in head-2) from head-1 probabilities. The labels 930 may include the correct player identification with the player's team formation/head indices and may be utilized to analyze a difference between the prediction 925 and the label 930 data sets for purposes of training the model.

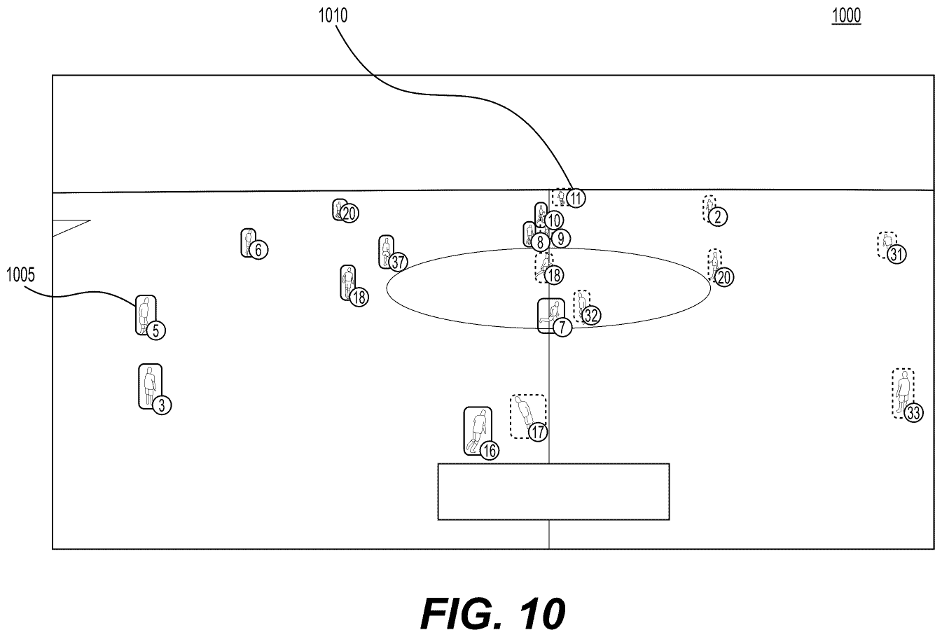

FIG. 10 depicts an exemplary frame output 1000 of the prediction module 126, according to example embodiments. This output shows how each player within a frame may be identified based on the techniques described herein. This may allow for players for each team (e.g., player 1005 of team A and player 1010 of team B) to be identified based on their respective formation.

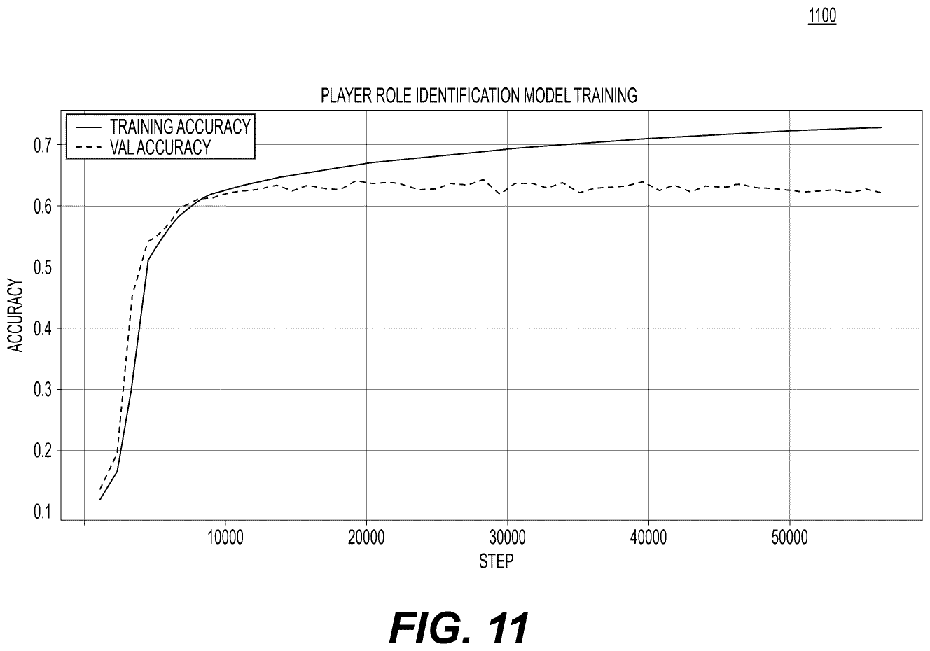

FIG. 11 depicts an exemplary graph 1100 of model training, according to example embodiments. This shows an exemplary scenario where the model described herein may have been trained on over a hundred soccer games and over twenty teams. Graph 1100 depicts how the training process may have achieved an accuracy of 73%, while the validation accuracy may have reached 65%.

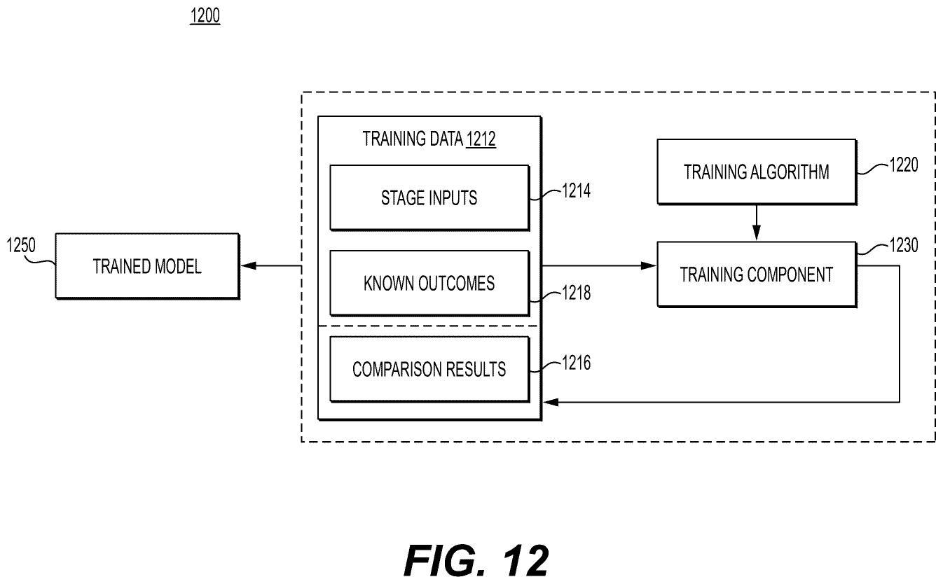

FIG. 12 depicts a flow diagram for training a machine learning model, in accordance with an aspect of the disclosed subject matter. As shown in flow diagram 1200 of FIG. 12, training data 1212 may include one or more of stage inputs 1214 and known outcomes 1218 related to a machine learning model to be trained. The stage inputs 1214 may be from any applicable source including a component or set shown in the figures provided herein. The known outcomes 1218 may be included for machine learning models generated based on supervised or semi-supervised training. An unsupervised machine learning model might not be trained using known outcomes 1218. Known outcomes 1218 may include known or desired outputs for future inputs similar to or in the same category as stage inputs 1214 that do not have corresponding known outputs.

The training data 1212 and a training algorithm 1220 may be provided to a training component 1230 that may apply the training data 1212 to the training algorithm 1220 to generate a trained machine learning model 1250. According to an implementation, the training component 1230 may be provided comparison results 1216 that compare a previous output of the corresponding machine learning model to apply the previous result to re-train the machine learning model. The comparison results 1216 may be used by the training component 1230 to update the corresponding machine learning model. The training algorithm 1220 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 1200 may be a trained machine learning model 1250.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

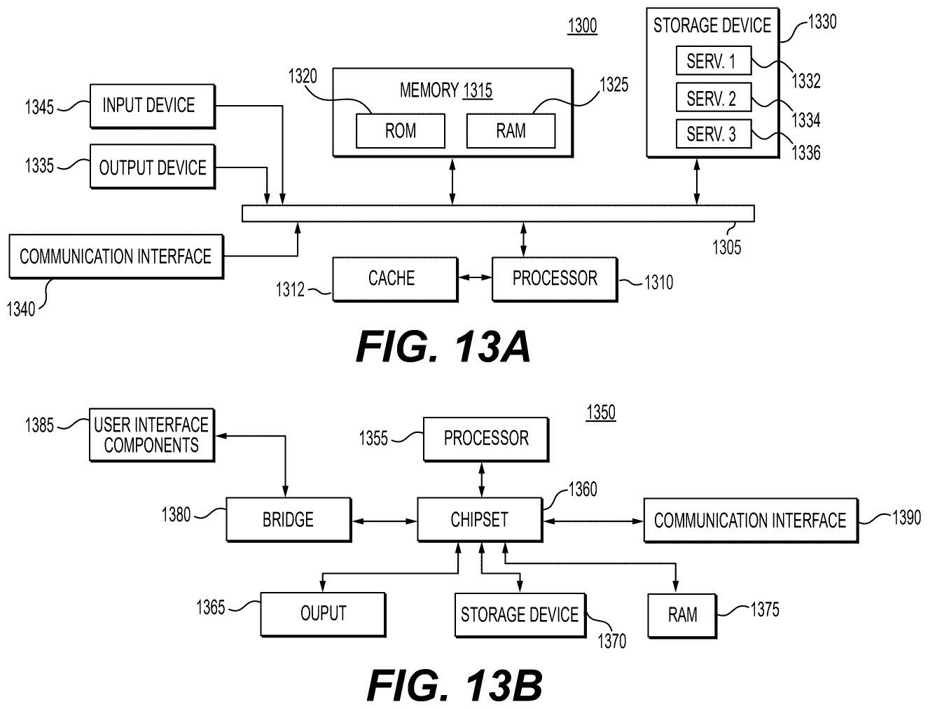

FIG. 13A illustrates an architecture of computing system 1300, according to example embodiments. System 1300 may be representative of at least a portion of organization computing system 104. One or more components of system 1300 may be in electrical communication with each other using a bus 1305. System 1300 may include a processing unit (CPU or processor) 1310 and a system bus 1305 that couples various system components including the system memory 1315, such as read only memory (ROM) 1320 and random access memory (RAM) 1325, to processor 1310. System 1300 may include a cache of high-speed memory connected directly with, in close proximity to, or integrated as part of processor 1310. System 1300 may copy data from memory 1315 and/or storage device 1330 to cache 1312 for quick access by processor 1310. In this way, cache 1312 may provide a performance boost that avoids processor 1310 delays while waiting for data. These and other modules may control or be configured to control processor 1310 to perform various actions. Other system memory 1315 may be available for use as well. Memory 1315 may include multiple different types of memory with different performance characteristics. Processor 1310 may include any general purpose processor and a hardware module or software module, such as service 1 1332, service 2 1334, and service 3 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction with the computing system 1300, an input device 1345 may represent any number of input mechanisms, such as a microphone for speech, a touch-sensitive screen for gesture or graphical input, keyboard, mouse, motion input, speech and so forth. An output device 1335 (e.g., display) may also be one or more of a number of output mechanisms known to those of skill in the art. In some instances, multimodal systems may enable a user to provide multiple types of input to communicate with computing system 1300. Communications interface 1340 may generally govern and manage the user input and system output. There is no restriction on operating on any particular hardware arrangement and therefore the basic features here may easily be substituted for improved hardware or firmware arrangements as they are developed.

Storage device 1330 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 1325, read only memory (ROM) 1320, and hybrids thereof.

Storage device 1330 may include services 1332, 1334, and 1336 for controlling the processor 1310. Other hardware or software modules are contemplated. Storage device 1330 may be connected to system bus 1305. In one aspect, a hardware module that performs a particular function may include the software component stored in a computer-readable medium in connection with the necessary hardware components, such as processor 1310, bus 1305, output device 1335, and so forth, to carry out the function.

FIG. 13B illustrates a computer system 1350 having a chipset architecture that may represent at least a portion of organization computing system 104. Computer system 1350 may be an example of computer hardware, software, and firmware that may be used to implement the disclosed technology. System 1350 may include a processor 1355, representative of any number of physically and/or logically distinct resources capable of executing software, firmware, and hardware configured to perform identified computations. Processor 1355 may communicate with a chipset 1360 that may control input to and output from processor 1355. In this example, chipset 1360 outputs information to output 1365, such as a display, and may read and write information to storage device 1370, which may include magnetic media, and solid-state media, for example. Chipset 1360 may also read data from and write data to RAM 1375. A bridge 1380 for interfacing with a variety of user interface components 1385 may be provided for interfacing with chipset 1360. Such user interface components 1385 may include a keyboard, a microphone, touch detection and processing circuitry, a pointing device, such as a mouse, and so on. In general, inputs to system 1350 may come from any of a variety of sources, machine generated and/or human generated.

Chipset 1360 may also interface with one or more communication interfaces 1390 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 1355 analyzing data stored in storage device 1370 or RAM 1375. Further, the machine may receive inputs from a user through user interface components 1385 and execute appropriate functions, such as browsing functions by interpreting these inputs using processor 1355.

It may be appreciated that example systems 1300 and 1350 may have more than one processor 1310 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A method for identifying a player in a sports event, the method comprising:
receiving a video feed of a sporting event;
capturing, by a computing system, positional data of a player in one or more video frames of the video feed;
receiving, by the computing system, team formation data for at least one team in the sporting event, wherein the team formation data comprises a player role associated with each player;
determining, by the computing system, a correspondence between the positional data of a player and the team formation data; and
generating, by the computing system, a player identification for the player, wherein the player identification is based on the correspondence between the positional data for the player and a player role from the team formation data.

2. The method of claim 1, wherein capturing position data of a player in one or more video frames of the video feed includes:
assigning an x, y coordinate values to the player relative to a field of the sporting event; and
assigning a time stamp to the x, y coordinate values.

3. The method of claim 1, wherein generating the player identification for the player further includes:
receiving a set of jersey numbers for each player in the sporting event;
identifying an associated number with the player from the video feed, the associated number having an assigned confidence value;
determining that the associated number matches an assigned jersey number from the set of jersey numbers; and
determining that the confidence value is above a threshold value.

4. The method of claim 1, wherein generating the player identification for the player further includes:
receiving a set of facial construction data for each player in the sporting event;
identifying data of a facial reconstruction of the player from the video feed; and
determining that the facial reconstruction of the player matches facial construction data received for the player.

5. The method of claim 1, wherein the team formation data includes a positional setup of players on a field of the sporting event.

6. The method of claim 1, wherein the team formation data is generated, by the computing system, based on exemplary data captured prior to a start of the sports event.

7. The method of claim 1, further including:
retrieving event data related to the sporting event, and
based upon the retrieved event data, updating the team formation data dynamically.

8. The method of claim 7, wherein updating the team formation data includes:
updating a formation for the at least one team or a listing of players in the sporting event.

9. The method of claim 1, wherein correspondence between the positional data of the player and the team formation data is determined by a graph recurrent neural network.

10. A system for identifying a player in a sports event, the system comprising:
a memory configured to store processor-readable instructions; and
a processor operatively connected to the memory, and configured to execute the instructions to perform operations comprising:
receiving a video feed of a sporting event;
capturing, by a computing system, positional data of a player in one or more video frames of the video feed;
receiving, by the computing system, team formation data for at least one team in the sporting event, wherein the team formation data comprises a player role associated with each player;
determining, by the computing system, a correspondence between the positional data of a player and the team formation data; and
generating, by the computing system, a player identification for the player, wherein the player identification is based on the correspondence between the positional data for the player and a player role from the team formation data.

11. The system of claim 10, wherein capturing position data of a player in one or more video frames of the video feed includes:
assigning an x, y coordinate values to the player relative to a field of the sporting event; and
assigning a time stamp to the x, y coordinate values.

12. The system of claim 11, wherein generating the player identification for the player further includes:
receiving a set of jersey numbers for each player in the sporting event;
identifying an associated number with the player from the video feed, the associated number having an assigned confidence value;
determining that the associated number matches an assigned jersey number from the set of jersey numbers; and
determining that the confidence value is above a threshold value.

13. The system of claim 10, wherein generating the player identification for the player further includes:
receiving a set of facial construction data for each player in the sporting event;
identifying data of a facial reconstruction of the player from the video feed; and
determining that the facial reconstruction of the player matches facial construction data received for the player.

14. The system of claim 10, wherein the team formation data includes a positional setup of players on a field of the sporting event.

15. The system of claim 10, wherein the team formation data is generated, by the computing system, based on exemplary data captured prior to a start of the sports event.

16. The system of claim 10, wherein the operations further comprise:
retrieving event data related to the sporting event, and
based upon the retrieved event data, updating the team formation data dynamically.

17. A non-transitory computer readable medium configured to store processor-readable instructions, wherein when executed by a processor, the instructions perform operations comprising:
receiving a video feed of a sporting event;
capturing, by a computing system, positional data of a player in one or more video frames of the video feed;
receiving, by the computing system, team formation data for at least one team in the sporting event, wherein the team formation data comprises a player role associated with each player;
determining, by the computing system, a correspondence between the positional data of a player and the team formation data; and
generating, by the computing system, a player identification for the player, wherein the player identification is based on the correspondence between the positional data for the player and a player role from the team formation data.

18. The non-transitory computer readable medium of claim 17, wherein capturing position data of a player in one or more video frames of the video feed includes:
assigning an x, y coordinate values to the player relative to a field of the sporting event; and
assigning a time stamp to the x, y coordinate values.

19. The non-transitory computer readable medium of claim 17, wherein generating the player identification for the player further includes:
receiving a set of jersey numbers for each player in the sporting event;
identifying an associated number with the player from the video feed, the associated number having an assigned confidence value;
determining that the associated number matches an assigned jersey number from the set of jersey numbers; and
determining that the confidence value is above a threshold value.

20. The non-transitory computer readable medium of claim 17, wherein generating the player identification for the player further includes:
receiving a set of facial construction data for each player in the sporting event;
identifying data of a facial reconstruction of the player from the video feed; and
determining that the facial reconstruction of the player matches facial construction data received for the player.
